(19) United States
(12) Patent Application Publication
(10) Pub. No.: US 2008/0205411 A1
(43) Pub. Date: Aug. 28, 2008

(54) Atm Network and Method of Operating Thereof

(76) Inventor: Per Kronborg Nielsen, Schwaikheim (DE)

Correspondence Address: COATS & BENNETT, PLLC, 1400 Crescent Green, Suite 300, Cary, NC, 27518, US

(21) Appl. No.: 11/815,280

(22) PCT Filed: Dec. 19, 2005
(86) PCT No.: PCT/EP05/56912

§ 371 Date: Feb. 18, 2008

(30) Foreign Application Priority Data
Feb. 3, 2005 (GB) 0502215.7

(51) Int. Cl. H04L 12/56

(52) U.S. Cl. 370/397; 370/396

(57) ABSTRACT

An Asynchronous Transfer Mode network (100) comprising at least one ATM node (102-106) and at least one network element (108) is disclosed. The network element is adapted to carry out signalling and routing in accordance with Private Network-Network Interface, PNNI, protocol for at least a portion of said ATM nodes. Said network element (108) is further adapted to allocate a separate time period for every one of said ATM nodes (102-106) connected to said network element (108) and to carry out said signalling and routing for every one of said connected ATM nodes (102-106) during said allocated time periods.

### FIELD OF THE INVENTION

The present invention relates to telecommunication and data networks in general, and in particular, the present invention relates to ATM networks supporting Private Network-Network Interface protocol.

### BACKGROUND OF THE INVENTION

Asynchronous Transfer Mode (ATM) is a telecommunications protocol defining packet-based transfer of information. ATM is also described as a connection-oriented system. In practice it means that a connection between points must be made prior to transfer. The path between communicating devices must also be established prior to transfer. ATM based networks allow for transferring network traffic, including voice, video, data and multimedia, at high speed. The network traffic is transferred within an ATM based network in the form of a packet called cell. The size of cell used in ATM networks is constant and equals 53 bytes, of which 5 bytes is allocated for headers and remaining 48 bytes for payload. The advantage of the small cell size is that ATM based networks are able to transmit video, audio, multimedia and computer data over the same network without the risk of blocking-up the line. Once a connection is established the bandwidth can be used entirely for data transport since the ATM network associates each cell with the virtual connection between origin and destination. This can be a virtual channel or virtual path. Since ATM is connection-oriented system and the cells are not used for establishing the connection and maintaining it and also cells do not contain the address of the destination, but only a virtual circuit identifier that distinguishes among many other virtual circuits sharing a link, the cells can have such a short header space (5 bytes).

The Asynchronous Transfer Mode Forum has defined a specification called Private Network-Network Interface also known as Private Node-Node Interface (PNNI) for routing connections in an ATM network. PNNI is both a routing and a signalling protocol defined for the purpose of building highly scaleable, highly resilient ATM switching networks. ATM routing is used to distribute information about the topology of the ATM network and reachability of an ATM address/device. The PNNI protocol consists of two components: routing protocol and signalling protocol. The first component—routing protocol—enables switches to automatically discover the topology and the characteristics of the links interconnecting the switches (i.e. allows for determining the path for routing call requests through the ATM network). The PNNI routing protocol allows for exchanging the hierarchical network topology between nodes. The second component is used to relay ATM connection requests within a network for point-to-point and point-to-multipoint connections (i.e. is responsible for establishing the ATM connection on the path determined by the routing protocol). The signalling protocol also handles functions such as soft Permanent Virtual Connections (SPVCs) and crankback indications.

Configuration and maintenance of routing tables in network nodes can be done either by implemented PNNI functions or manually by a network engineer. Without PNNI functionality implemented in the ATM node the operation of the network will get very complex and is very error prone and increases operation cost because on every node the connections must be manually configured. The problem becomes acute in big networks comprising tens or hundreds of ATM nodes. In ATM network the trend is to push the nodes towards the access. Therefore the nodes get smaller and smaller. Implementing complex protocols as PNNI into ATM switches increases the complexity and cost per node. The problem with implementing PNNI in every ATM switch is that ATM switches are relatively simple, but if implementation of PNNI into an ATM switch is required the resulting technical solution will be complex and expensive.

What is desired, is an apparatus and method that allows for providing PNNI functionalities to ATM networks in a simple and inexpensive manner that avoids disadvantages of prior art solutions.

### SUMMARY OF THE INVENTION

Accordingly, the invention seeks to preferably mitigate, alleviate or eliminate one or more of the disadvantages mentioned above singly or in any combination.

According to a first aspect of the present invention there is provided an Asynchronous Transfer Mode network as claimed in claim 1.

According to a second aspect of the present invention there is provided a network element for use in an ATM network as claimed in claim 14.

According to a third aspect of the present invention there is provided a method of operating an ATM network as claimed in claim 26.

Further aspects of the present invention are as claimed in the dependent claims.

The present invention beneficially allows for deploying cost effective networks based on reliable ATM technology with full support of PNNI protocol. The present invention allows for deployment PNNI support in ATM networks, which originally do not support PNNI protocol. This is especially beneficial in case of small networks, which grow and become more complicated and more difficult to manage with deployment of new ATM nodes. The nodes of the network according to the present invention act as fully compliant ATM switches. The present invention further ensures interoperability by inserting proven protocols.

### BRIEF DESCRIPTION OF THE DRAWINGS

The present invention will be understood and appreciated more fully from the following detailed description taken in conjunction with the drawings in which:

FIG. 1 is a diagram illustrating an ATM network in accordance with one embodiment of the present invention;

FIG. 2 is a diagram illustrating an ATM network in accordance with one embodiment of the present invention;

FIG. 3 is a diagram illustrating an ATM network management in accordance with one embodiment of the present invention;

FIG. 4 is a diagram illustrating a Network Element in accordance with one embodiment of the present invention.

### DESCRIPTION OF AN EMBODIMENT OF THE INVENTION

The term “in-band connection” herein below refers to the path from the network element to the ATM switches, which uses connections through the existing transport network

The term “out-band connection” herein below refers to a Data Communication Network DCN common with existing network management network.

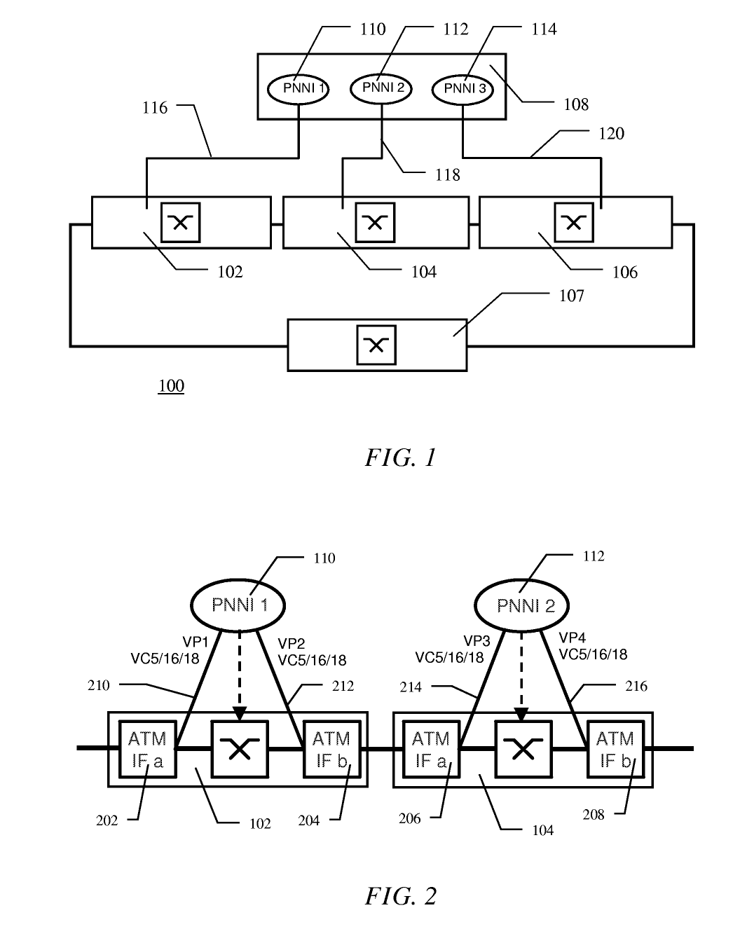

Referring to FIG. 1 one embodiment of an ATM network according to the present invention is illustrated.

In the embodiment of FIG. 1 the ATM network 100 comprises a group of ATM nodes 102-107 and a Network Element 108. Said ATM nodes 102-107 comprise ATM switches 302, 308. In one embodiment said network element 108 is connected to a portion of said ATM nodes 102-106. However, in alternative embodiments the network element may be connected to all ATM swiches of the ATM network 100. The Network Element 108 is a proxy PNNI node and is adapted to carry out signalling and routing in accordance with Private Network-Network Interface protocol for every one of said ATM nodes 102-106 connected to said Network Element 108. The proxy PNNI node (or the Network Element 108) acts as a PNNI instance per ATM node and therefore reduces the complexity per ATM node. The configuration as illustrated in FIG. 1 and described above allows for building ATM networks with ATM nodes, which operate like regular ATM compliant switches supporting PNNI protocol, but the PNNI functionality, and specialized hardware and software providing PNNI, is not built-in in any one of said ATM nodes connected to the Network Element 108. The ATM nodes 102-106 still perform switching, however the PNNI signalling and routing is overtaken by the Network Element 108.

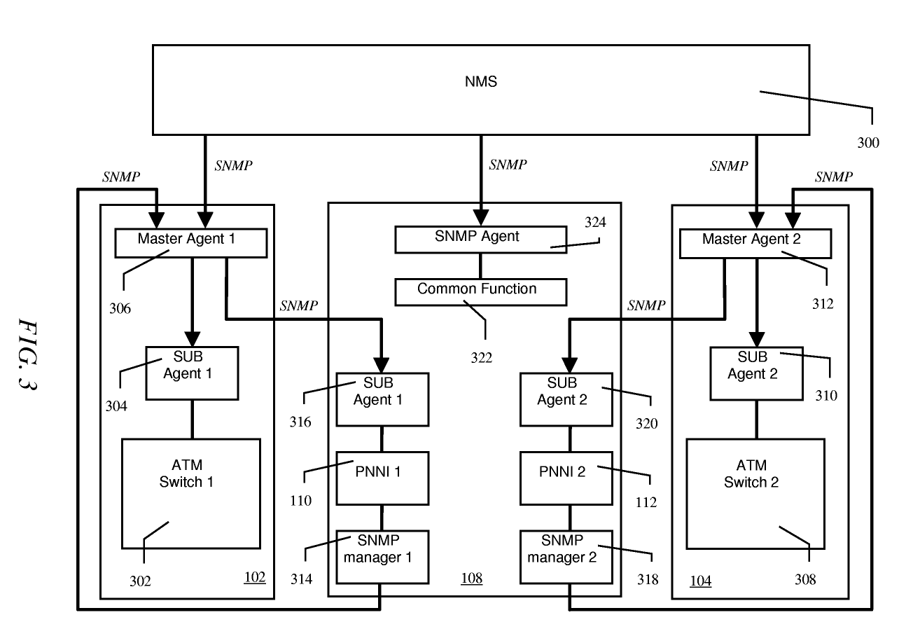

Reference is now made to FIG. 2. The Network Element 108 is connected to the ATM nodes 102-106 in-band or out-band by means of a Virtual Paths (VP). Every ATM node 102-106 is represented in the Network Element 108 in one separate PNNI instance 110-114. One PNNI instance has one routing domain. Within the routing domain a routing table for this specific ATM node is stored. The routing domain ensures that no routing is performed internally in the Network Element 108 between two ATM nodes 102-106. The signalling interface 202, 204 of the first ATM node 102 is also represented as signalling interface in the PNNI instance on the Network Element 108. Every ATM node 102-106 is connected by a separate VP to the Network Element 108. In alternative embodiments redundant VPs may be added for connecting the ATM nodes 102-106 and the Network Element 108 to ensure operability in case of connection failure.

In alternative embodiments every physical interface 202-208 may have more signalling VP, which are also represented in the Network Element 108. Every VP 210-214 is represented in the Network Element 108 in a form of appropriate routing entry in the routing table for the relevant ATM node. Similarly every VP 210-214 is represented by separate signalling entries in the signalling table for the relevant ATM node.

In a preferred embodiment the Network Element 108 is also adapted to carry out functions of Integrated Local Management Interface (ILMI) and ATM Inter-Network Interface (AINI) for the ATM nodes 102-106 connected to said Network Element 108. In a preferred embodiment PNNI, AINI and ILMI functions reside on the Network Element 108. It is enough to have one ILMI and one AINI instance residing on the Network Element 108 to serve all the ATM nodes 102-106 connected to said Network Element 108. However in alternative embodiments more than one ILMI and/or AINI instance may reside on the Network Element 108.

In yet another embodiment the ILM and/or AINI functions may reside on the ATM nodes and the PNNI on said Network Element 108.

The communication between the Network Element 108 and the ATM nodes 102-106 connected to the network element is carried out via Simple Network Management Protocol. It is envisaged, however, that other protocols may be implemented in order to provide efficient communications between the Network Element 108 and the ATM nodes 102-106. Alternatively said communication between the Network Element 108 and the ATM nodes can be carried out via Corba or QD2 protocols.

As it is well known in the art the ATM networks are connection-oriented. It means that a virtual channel (VC) must be set up across the ATM network prior to data transfer. There are two types of ATM connections defined in ATM standard: Virtual paths (VP) and virtual channels (VC). A virtual path is a bundle of virtual channels. Virtual paths are identified by virtual path identifiers (VPI). Virtual channels are identified by a combination of a VPI and a virtual channel identifier (VCI).

PNNI and ILMI operate over reserved virtual channel connections (VCC), defined by a combination of VPI and VCI. Therefore for signalling VCI=5, for routing VCI=18 and for ILMI VCI=16 are reserved in every VP (i.e. VPI=X), which must provide routing and signalling. To simulate that the Network Element 108 has signalling, routing and ILMI the VC 5, 16 and 18 of each signalling VP 210-214 must be switched through the ATM nodes 102-106 to the Network Element 108.

In operation, the signalling VPs (VP1 210 and VP2 212) on the interfaces 202 and 204 containing respective VCs are packed in a common VP back to the Network Element 108 and terminated on the PNNI instance 110.

From the network point of view, e.g. the Network Management System (NMS), the ATM nodes 102-106 look like an ATM Forum compliant ATM nodes with complete signalling and routing functionality for any neighbour switch/node. A neighbour to the ATM node is any external node supporting PNNI or AINI and connected to a physical interface of the ATM node. The ATM nodes can be clustered in one or more groups and can even be completely separated through the ATM network. It is worth to note that only those VPs, which are intended to provide signalling, must have AINI, PNNI and ILMI on their interfaces.

In operation, the Network Element 108 carries out the PNNI and ILMI functions of one of said connected ATM nodes 102-106 at a time. Once the job is done the Network Element 108 switches to another ATM node and repeats the operation. All the ATM nodes 102-106 connected to the Network Element 108 are served in a round-robin fashion. The order in which the ATM nodes are served by the network element is predefined in a dedicated table. It is envisaged, however, that alternative scenarios of allocating time periods for serving the ATM nodes 102-106 by the Network Element 108 are possible.

The Network Management System (NMS) 300 issues all network relevant set-up commands via SNMP to the first ATM node 102. The entity responsible for communication with the NMS 300 within the first ATM node 102 is a first SNMP master agent 306. The first SNMP master agent 306 relays protocol relevant SNMP commands to a first subagent 316 of the Network Element 108. The same is shown on FIG. 2 by the dotted line. Depending on the information in the first PNNI instance 110 the Network Element 108 issues one or more SNMP commands through a first SNMP manager 314 to the first ATM node's Master agent 306. These SNMP commands get in to the first ATM switch 302 through the first subagent 304 and, for example, set up connections on the first ATM switch 302. The supervision and control of the Network Element 108 is carried out through the local SNMP agent 324 and the Common Function Module 322. The Common Function Module 322 is responsible for supervising the hardware and software modules within the Network Element 108. If an error occurs in the Network Element 108 then the error will be reported by the Common Function Module 322 through the SNMP Agent 324 to the NMS 300. Common parameters such as IP addresses can also be set in the Common Function Module 322.

Once configuration of the first ATM node is completed a second PNNI instance 112 of the Network Element 108 starts to carry out configuration (e.g. setting up connections on the second ATM switch 308) of the remaining nodes 104-106.

The Network Management System (NMS) 300 issues all network relevant set-up commands via SNMP to the second ATM node 104. The entity responsible for communication with the NMS 300 within the second ATM node 104 is a second SNMP master agent 312. The second SNMP master agent 312 relays protocol relevant SNMP commands to a second subagent 320 of the Network Element 108. The same is shown on FIG. 2 by the dotted line. Depending on the information in the second PNNI instance 112 the Network Element 108 issues one or more SNMP commands through a second SNMP manager 318 to the second Master Agent 312 of the second ATM node 104. These SNMP commands get in to the second ATM switch 308 through the second subagent 310 and, for example, set up connections on the second ATM switch 308.

This network management setup ensures that the ATM nodes 102-104 act as ATM forum compliant ATM switches.

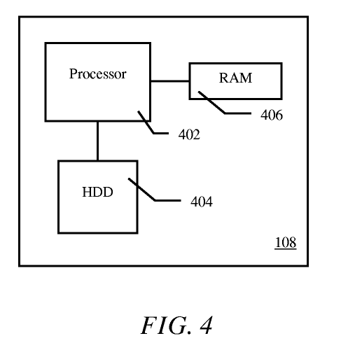

The reference is now made to FIG. 4. With a great simplification the Network Element 108 is shown from the hardware point of view.

The Network Element 108 a processing unit 402, a mass memory 404 and a Random Access Memory (RAM) 406. In one embodiment the mass memory 404 can be a hard disk drive, but memory storage devices like Compact Flash, Secure Digital, MultMedia Card and others can be also used. Similarly the RAM memory can be static RAM (SRAM), dynamic RAM (DRAM), double data rate synchronous dynamic random access memory (DDR SDRAM) or any other type of read/write RAM. In said mass memory 404 data representing every PNNI, ILMI and AINI instances residing on said Network Element 108 is stored.

In operation, to start carrying out PNNI, ILMI and AINI functionalities for the first ATM node 102 the processing unit 402 clears the RAM memory 406. Next the processing unit 402 loads to said RAM memory 406 from said mass memory 404 data representing the PNNI, ILMI and AINI instances of the first ATM node 102. Once the correct data is loaded to said RAM memory 406 a complete set of PNNI, ILMI and AINI instances is created for said first ATM node 102. Then the Network Element 108 starts carrying the PNNI, ILMI and AINI functions for said first ATM node 102.

The invention can be implemented in any suitable form including hardware, software, software embedded in hardware or any combination of these. The functionality defined in the present invention may be implemented in a plurality of units or as part of other functional units. In consequence, the invention may be physically and functionally distributed between different units and processors.

1-31. (canceled)

32. An Asynchronous Transfer Mode (ATM) network comprising:
a plurality of ATM nodes; and
a network element communicatively connected to one or more of the plurality of ATM nodes, and configured to perform signaling and routing functions for the one or more ATM nodes according to a Private Network-Network Interface (PNNI) protocol.

33. The network of claim 32 wherein the network element is further configured to perform Integrated Local Management Interface (ILMI) functions for the one or more ATM nodes.

34. The network of claim 32 wherein the network element is further configured to perform ATM Inter-Network Interface (AINI) functions for the one or more ATM nodes.

35. The network of claim 32 wherein all of the plurality of ATM nodes communicatively connect to the network element by at least one virtual path.

36. The network of claim 35 wherein the virtual path comprises an in-band connection.

37. The network of claim 35 wherein the virtual path comprises an out-band connection.

38. The network of claim 32 wherein the network element is further configured to allocate a separate time period to each of the one or more ATM nodes connected to the network element, and to perform the signaling and routing functions for each of the one or more ATM nodes during the allocated time period.

39. The network of claim 38 wherein the network element is further configured to perform Integrated Local Management Interface (ILMI) functions for each of the one or more ATM nodes during the allocated time period.

40. The network of claim 38 wherein the network element is further configured to perform ATM Inter-Network Interface (AINI) functions for each of the one or more ATM nodes during the allocated time period.

41. The network of claim 32 wherein the network element comprises one PNNI instance for each of the one or more ATM nodes.

42. The network of claim 41 wherein each PNNI instance comprises one routing table and one signaling table associated with its corresponding ATM node.

43. The network of claim 32 wherein the network is configured to allow communication between the network element and the one or more ATM nodes according to at least one of a Simple Network Management Protocol (SNMP), a Corba protocol, and a QD2 protocol.

44. The network of claim 32 wherein the one or more ATM nodes comprise ATM switches.

45. A network element for an Asynchronous Transfer Mode (ATM) network comprising:
a network element communicatively connected to one or more ATM nodes in the ATM network, and configured to perform signaling and routing functions for the one or more ATM nodes according to a Private Network-Network Interface (PNNI) protocol; and
a control function module configured to supervise and control the network element.

46. The network element of claim 45 wherein the network element is further configured to perform Integrated Local Management Interface (ILMI) functions for the one or more ATM nodes.

47. The network element of claim 45 wherein the network element is further configured to perform ATM Inter-Network Interface (AINI) functions for the one or more ATM nodes.

48. The network element of claim 45 wherein the network element is further configured to establish a connection to the one or more ATM nodes, such that each ATM node connects to the network element by at least one virtual path.

49. The network element of claim 48 wherein the virtual path comprises an in-band connection.

50. The network element of claim 48 wherein the virtual path comprises an out-band connection.

51. The network element of claim 45 wherein the network element is further configured to allocate a separate time period for each of the one or more ATM nodes connected to the network element, and to perform the signaling and routing functions for each of the one or more connected ATM nodes during its allocated time period.

52. The network element of claim 51 wherein the network element is further configured to perform Integrated Local Management Interface (ILMI) functions for each of the one ore more connected ATM nodes during the allocated time period.

53. The network element of claim 51 wherein the network element is further configured to perform ATM Inter-Network Interface (AINI) functions for each of the one ore more connected ATM nodes during the allocated time period.

54. The network element of claim 45 further comprising one PNNI instance for each of the one or more ATM nodes.

55. The network element of claim 54 wherein a PNNI instance comprises one routing table and one signaling table associated with a corresponding ATM node.

56. The network element of claim 45 wherein the network element is further configured to communicate with the one or more ATM nodes according to at least one of a Simple Network Management Protocol (SNMP), a Corba protocol, and a QD2 protocol.

57. A method of operating an Asynchronous Transfer Mode (ATM) network having one or more ATM nodes connected to a network element via a virtual path, the network element comprising a Private Network-Network Interface (PNNI) instance having one routing table and one signaling table for each of the one or more ATM nodes, the method comprising:
switching a first virtual channel link from a first ATM node to a network element;
switching a second virtual channel link from the first ATM node to the network element;
performing signaling and routing functions for the first ATM node by a first PNNI instance of the network element, the first PNNI instance being assigned to the first ATM node;
terminating the connections between the first and second virtual channel links with the first ATM node and the network element.

58. The method of claim 57 wherein the first virtual channel link comprises virtual channel 5 (VC5), and the second virtual channel link comprises virtual channel 18 (VC 18).

59. The method of claim 57 wherein performing signaling and routing functions for the first ATM node comprises:
switching a third virtual channel link from the first ATM node to the network element;
determining a status of one or more neighbor ATM nodes connected to the first ATM node via a physical link; and
negotiating a common set of operational parameters according to an Integrated Local Management Interface (ILMI) protocol.

60. The method of claim 59 wherein the third virtual channel link comprises virtual channel 16 (VC16).

61. The method of claim 57 further comprising performing ATM Inter-Network Interface (AINI) functions for the first ATM node by the network element.

62. The method of claim 57 further comprising, for every one of the one or more ATM nodes connected to the network element:
switching a virtual channel link from the ATM node to the network element;
switching another virtual channel link from the ATM node to the network element;
performing signaling and routing functions for the ATM node according to a PNNI instance of the network element assigned to the ATM node;
terminating the connection of the virtual channel links with the ATM node and the network element.

63. The method of claim 62 further comprising performing the steps for each of the ATM nodes connected to the network element in a round robin manner.

64. The method of claim 57 further comprising communicating data between the network element and the first ATM node according to at least one of a Simple Network Management Protocol (SNMP), a Corba protocol, and a QD2 protocol.
